(19) United States
(12) Patent Application Publication
(10) Pub. No.: US 2018/0013887 A1
(43) Pub. Date: Jan. 11, 2018

(54) SUBJECT LINE FOR INCOMING CALLS WITHIN WIRELESS COMMUNICATION NETWORK SERVICES

(71) Applicant: T-Mobile USA, Inc., Bellevue, WA (US)

(72) Inventor: Karthik Iyer, Bellevue, WA (US)

(21) Appl. No.: 15/203,534

(22) Filed: Jul. 6, 2016

(51) Int. Cl. H04M 3/436; H04W 4/02; H04M 1/725; H04W 4/22; H04W 4/16

(52) U.S. Cl. CPC H04M 3/4365; H04W 4/22; H04W 4/16; H04M 1/72536; H04W 4/02; H04M 2242/04

(57) ABSTRACT

Calls, e.g., voice calls (telephone calls) and video calls, made within a wireless communication network include a subject line that may or may not be included with an identification of the party making the call. Thus, when a user within the wireless communication network receives a call on a mobile device, prior to answering the call, a subject of the call is displayed to the user or audibly provided to the user. The subject of a call may be automatically provided to the user. In embodiments, a prompt may be required from the user in order to display or hear the subject of the incoming call.

### BACKGROUND

In recent years, telecommunication devices have advanced from offering simple voice calling services within wireless communication networks to providing users with many new features. Telecommunication devices now provide messaging services such as email, text messaging, and instant messaging; data services such as Internet browsing; media services such as storing and playing a library of favorite songs; location services; and many others. Thus, telecommunication devices, referred to herein as mobile devices, are often used in multiple contexts. In addition to the new features provided by the telecommunication devices, users of such telecommunication devices have greatly increased. Such an increase in users is only expected to continue and in fact, it is expected that there could be a growth rate of twenty times more users in the next few years alone.

With the growth in users of wireless communication networks, the number of voice and video calls made within the wireless communication networks is continually increasing. Unfortunately, there currently is no way for recipients of such calls to determine whether or not they should accept the call or whether they should return a call quickly or leisurely if they miss or do not accept the call.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 schematically illustrates a wireless communication network, in accordance with various embodiments.

FIG. 2 schematically illustrates a mobile device for use within the wireless communication network of FIG. 1, where the mobile device displays a subject with incoming calls, in accordance with various embodiments.

FIG. 3 is a flowchart illustrating an example method of placing calls that include a subject within the wireless communication network of FIG. 1, in accordance with various embodiments.

FIG. 4 a flowchart illustrating an example method of receiving calls that include a subject within the wireless communication network of FIG. 1, in accordance with various embodiments

FIG. 5 illustrates a component level view of an example mobile device configured for use in the wireless communication network of FIG. 1, where the mobile device displays a subject with incoming calls.

FIG. 6 illustrates a component level view of a server configured for use in the arrangement of FIG. 1 to provide various services of the wireless communication network of FIG. 1.

### DETAILED DESCRIPTION

Described herein are techniques and an architecture for providing services on a wireless communication network in which voice calls (telephone calls) and video calls made within the wireless communication network include information regarding the subject of the calls that is displayed on a recipient's mobile device. As used herein, mobile devices include devices configured as Internet of Things (IoT) devices. Generally, Internet of Things refers to a network of physical objects—devices, vehicles, buildings and other items embedded with electronics, software, sensors, and network connectivity—that enables these objects to collect and exchange data. IoT allows objects to be sensed and controlled remotely across existing network infrastructure, creating opportunities for more direct integration of the physical world into computer-based systems, and resulting in improved efficiency, accuracy and economic benefit. When IoT is augmented with sensors and actuators, the technology becomes an instance of the more general class of cyber-physical systems, which also encompasses technologies such as smart grids, smart homes, intelligent transportation and smart cities. Each thing is uniquely identifiable through its embedded computing system, but is able to interoperate within the existing Internet infrastructure.

In embodiments, calls, e.g., voice calls (telephone calls) and video calls, made within a wireless communication network include a subject line that may or may not be included with an identification of the party making the call. Thus, when a user within the wireless communication network receives a call on a mobile device, prior to answering the call, a subject of the call is displayed to the user or audibly provided to the user. The subject may be displayed in addition to an identification of the caller. The subject of a call may be automatically provided to the user. In embodiments, a prompt may be required from the user in order to display or hear the subject of the incoming call.

In order to include the subject with the incoming call, when a party is making a call, the party is prompted for information regarding the subject of the call being made. Once the information has been provided by the party, the party can then make the call. The information regarding the subject can be provided by speaking or typing the information. Additionally, a preprogrammed list of subjects can also be provided to the party and the party can make a selection from the list. The list can include various subjects such as, but not limited to, urgent, emergency, call back, please do not ignore, social, business, personal, catch-up, confirming plans, returning your call, etc.

In accordance with various embodiments, a subject for a call may be an emergency. In such embodiments, the subject may include the location of the party making the call. The location may be entered by the party making the call or may be automatically provided by the device being used to make the call. Additionally, the subject may also, or instead, include the type of emergency so that the recipient of the call can know what services need to be provided to the party making the call in response to the emergency.

In embodiments, the subject stays with the identification of the party making the call within call logs. Thus, if the recipient of the call misses the call or does not accept the call, the subject can be automatically displayed to the recipient via the call log along with the identity of the party making the call. The subject may also be provided to the recipient manually in response to a prompt from the recipient.

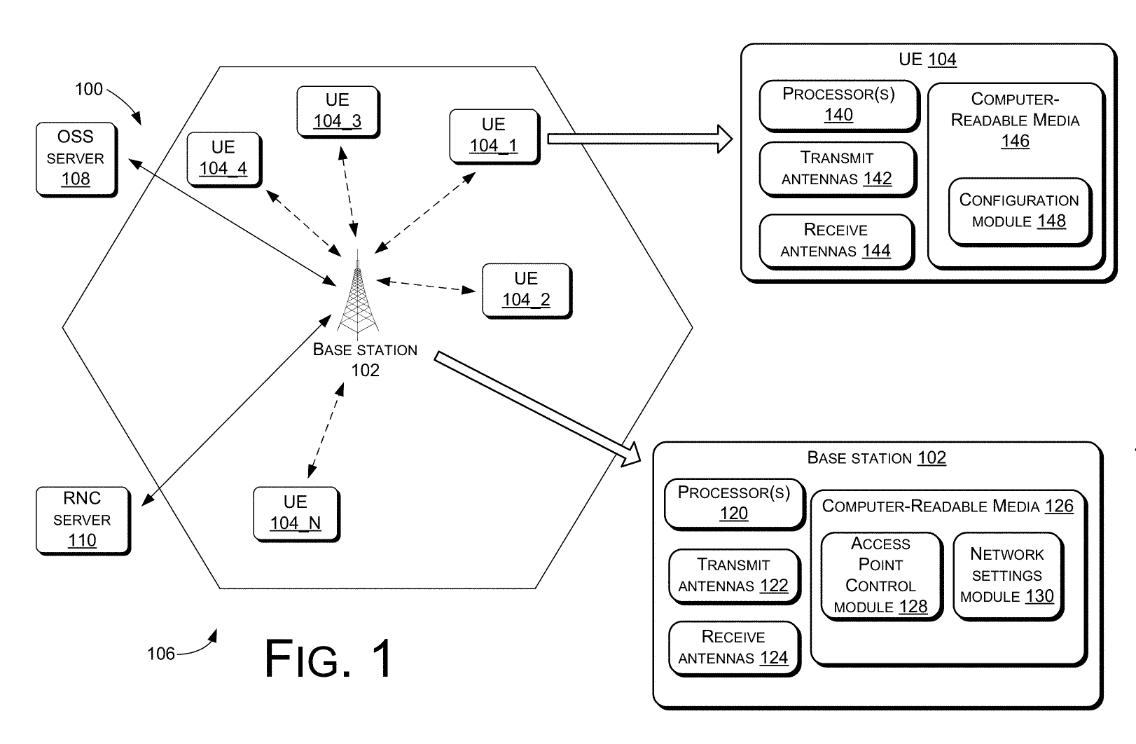

FIG. 1 illustrates a wireless communication network 100 (also referred to herein as network 100). The network 100 comprises a base station (BS) 102 communicatively coupled to a plurality of user devices, referred to as UEs 104_1, 104_2, . . . , 104_N, where N is an appropriate integer. The BS 102 serves UEs 104 located within a geographical area, e.g., within a macro cell 106. FIG. 1 illustrates the macro cell 106 to be hexagonal in shape, although other shapes of the macro cell 106 may also be possible. In general, the network 100 comprises a plurality of macro cells 106, with each macro cell 106 including one or more BSs 102.

In an embodiment, the UEs 104_1, . . . , 104_N may comprise any appropriate devices for communicating over a wireless communication network. Such devices include mobile telephones, cellular telephones, mobile computers, Personal Digital Assistants (PDAs), radio frequency devices, handheld computers, laptop computers, tablet computers, desktop computers, palmtops, pagers, devices configured as IoT devices, integrated devices combining one or more of the preceding devices, and/or the like. As such, UEs 104_1, . . . , 104_N may range widely in terms of capabilities and features. For example, one of the UEs 104_1, . . . , 104_N may have a numeric keypad, a capability to display only a few lines of text and be configured to interoperate with only Global System for Mobile Communications (GSM) networks. However, another of the UEs 104_1, . . . , 104_N (e.g., a smart phone) may have a touch-sensitive screen, a stylus, an embedded GPS receiver, and a relatively high-resolution display, and be configured to interoperate with multiple types of networks. UEs 104_1, . . . , 104_N may also include SIM-less devices (i.e., mobile devices that do not contain a functional subscriber identity module (“SIM”)), roaming mobile devices (i.e., mobile devices operating outside of their home access networks), and/or mobile software applications.

In an embodiment, the BS 102 may communicate voice traffic and/or data traffic with one or more of the UEs 104_1, . . . , 104_N. The BS 102 may communicate with the UEs 104_1, . . . , 104_N using one or more appropriate wireless communication protocols or standards. For example, the BS 102 may communicate with the UEs 104_1, . . . , 104_N using one or more standards, including but not limited to GSM, Time Division Multiple Access (TDMA), Universal Mobile Telecommunications System (UMTS), Evolution-Data Optimized (EVDO), Long Term Evolution (LTE), Generic Access Network (GAN), Unlicensed Mobile Access (UMA), Code Division Multiple Access (CDMA) protocols (including IS-95, IS-2000, and IS-856 protocols), Advanced LTE or LTE+, Orthogonal Frequency Division Multiple Access (OFDM), General Packet Radio Service (GPRS), Enhanced Data GSM Environment (EDGE), Advanced Mobile Phone System (AMPS), WiMAX protocols (including IEEE 802.16e-2005 and IEEE 802.16m protocols), High Speed Packet Access (HSPA), (including High Speed Downlink Packet Access (HSDPA) and High Speed Uplink Packet Access (HSUPA)), Ultra Mobile Broadband (UMB), and/or the like.

The BS 102 may be communicatively coupled (e.g., using a backhaul connection, illustrated using solid lines in FIG. 1) to a number of backhaul equipment, e.g., an operation support subsystem (OSS) server 108, a radio network controller (RNC) 110, and/or the like. The RNC 110 generally serves as a gateway for the wireless communication network 100 and can also be in the form of a mobility management entity when the wireless communication network 100 operates according to the long term evolution (LTE) standard or LTE Advanced standard.

In an embodiment, the base station 102 may comprise processors 120, one or more transmit antennas (transmitters) 122, one or more receive antennas (receivers) 124, and computer-readable media 126. The processors 120 may be configured to execute instructions, which may be stored in the computer-readable media 126 or in other computer-readable media accessible to the processors 120. In some embodiments, the processors 120 are a central processing unit (CPU), a graphics processing unit (GPU), or both CPU and GPU, or any other sort of processing unit. The base station 102 can also be in the form of a Node B (where the wireless communication network 100 is 3G UMTS network) or in the form of an eNode B (where the wireless communication network 100 operates according to the LTE standard or LTE Advanced standard).

The one or more transmit antennas 122 may transmit signals to the UEs 104_1, . . . , 104_N, and the one or more receive antennas 124 may receive signals from the UEs 104_1, . . . , 104_N. The antennas 122 and 124 include any appropriate antennas known in the art. For example, antennas 122 and 124 may include radio transmitters and radio receivers that perform the function of transmitting and receiving radio frequency communications. In an embodiment, the antennas 122 and 124 may be included in a transceiver module of the BS 102.

The computer-readable media 126 may include computer-readable storage media (“CRSM”). The CRSM may be any available physical media accessible by a computing device to implement the instructions stored thereon. CRSM may include, but is not limited to, random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical disk storage, magnetic cassettes, magnetic tape, magnetic disk storage or other magnetic storage devices, or any other medium which can be used to store the desired information and which can be accessed by the base station 102. The computer-readable media 126 may reside within the base station 102, on one or more storage devices accessible on a local network to the base station 102, on cloud storage accessible via a wide area network to the base station 102, or in any other accessible location.

The computer-readable media 126 may store modules, such as instructions, data stores, and so forth that are configured to execute on the processors 120. For instance, the computer-readable media 126 may store an access point control module 128 and a network settings module 130, as will be discussed in more detail herein later.

Although FIG. 1 illustrates the computer-readable media 126 in the BS 102 storing the access point control module 128 and the network settings module 130, in various other embodiments, the access point control module 128, the network settings module 130, and one or more other modules (not illustrated, may be stored in another component of the network 100 (e.g., other than the BS 102). For example, one or more of these modules may be stored in a computer-readable media included in the OSS server 108, the RNC 110, another appropriate server associated with the network 10, and/or the like.

Although not illustrated in FIG. 1, various other modules (e.g., an operating system module, basic input/output systems (BIOS), etc.) may also be stored in the computer-readable media 126. Furthermore, although not illustrated in FIG. 1, the base station 102 may comprise several other components, e.g., a power bus configured to supply power to various components of the base station 102, one or more interfaces to communicate with various backhaul equipment, and/or the like.

In an embodiment, the UEs 104 may comprise processors 140, one or more transmit antennas (transmitters) 142, one or more receive antennas (receivers) 144, and computer-readable media 146. The processors 140 may be configured to execute instructions, which may be stored in the computer-readable media 146 or in other computer-readable media accessible to the processors 140. In some embodiments, the processors 140 is a central processing unit (CPU), a graphics processing unit (GPU), or both CPU and GPU, or any other sort of processing unit. The one or more transmit antennas 142 may transmit signals to the base station 102, and the one or more receive antennas 144 may receive signals from the base station 102. In an embodiment, the antennas 142 and 144 may be included in a transceiver module of the UE 104.

The computer-readable media 146 may also include CRSM. The CRSM may be any available physical media accessible by a computing device to implement the instructions stored thereon. CRSM may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the UE 14.

The computer-readable media 146 may store several modules, such as instructions, data stores, and so forth that are configured to execute on the processors 140. For instance, the computer-readable media 140 may store a configuration module 148. Although not illustrated in FIG. 1, the computer-readable media 146 may also store one or more applications configured to receive and/or provide voice, data and messages (e.g., short message service (SMS) messages, multi-media message service (MMS) messages, instant messaging (IM) messages, enhanced message service (EMS) messages, etc.) to and/or from another device or component (e.g., the base station 102, other UEs, etc.).

Although not illustrated in FIG. 1, the UEs 104 may also comprise various other components, e.g., a battery, a charging unit, one or more network interfaces, an audio interface, a display, a keypad or keyboard, a GPS receiver and/or other location determination component, and other input and/or output interfaces.

Although FIG. 1 illustrates only one UE (UE 104_1) in detail, each of the UEs 104 _2, . . . , 104_N may have a structure that is at least in part similar to that of the UE 104 1. For example, similar to the UE 104_1, each of the UEs 104 _2, . . . , 104_N may comprise processors, one or more transmit antennas, one or more receive antennas, and computer-readable media including a configuration module.

In an embodiment, the network settings module 130 stored in the computer-readable media 126 maintains a plurality of network settings associated with the network 10. Individual network settings maintained by the network settings module 130 may be pertinent to a single UE of the UEs 104_1, . . . , 104_N, a subset of the UEs 104_1, . . . , 104_N, or each of the UEs 104_1, . . . , 104_N. For example, a network setting of the plurality of network settings may specify a maximum bit rate at which a UE (or each of the UEs 104_1, . . . , 104_N) may transmit data to the BS 102. Another network setting of the plurality of network settings may specify a transmit time interval (tti) used by each of the UEs 104_1, . . . , 104_N to transmit data to the BS 102. Yet another network setting of the plurality of network settings may specify a maximum power that each of the UEs 104_1, . . . , 104_N may use to transmit data to the BS 102. The plurality of network settings maintained by the network settings module 130 may also include any other appropriate type of network settings.

In an embodiment, one or more of the plurality of network settings maintained by the network settings module 130 may be communicated to the UEs 104_1, . . . , 104_N (e.g., by the transmit antennas 122 to the receive antennas 144 of the UEs 104_1, . . . , 104_N). Based on receiving the network settings, the UEs 104_1, . . . , 104_N (e.g., the corresponding configuration modules 148) may configure themselves and communicate with the BS 102 accordingly.

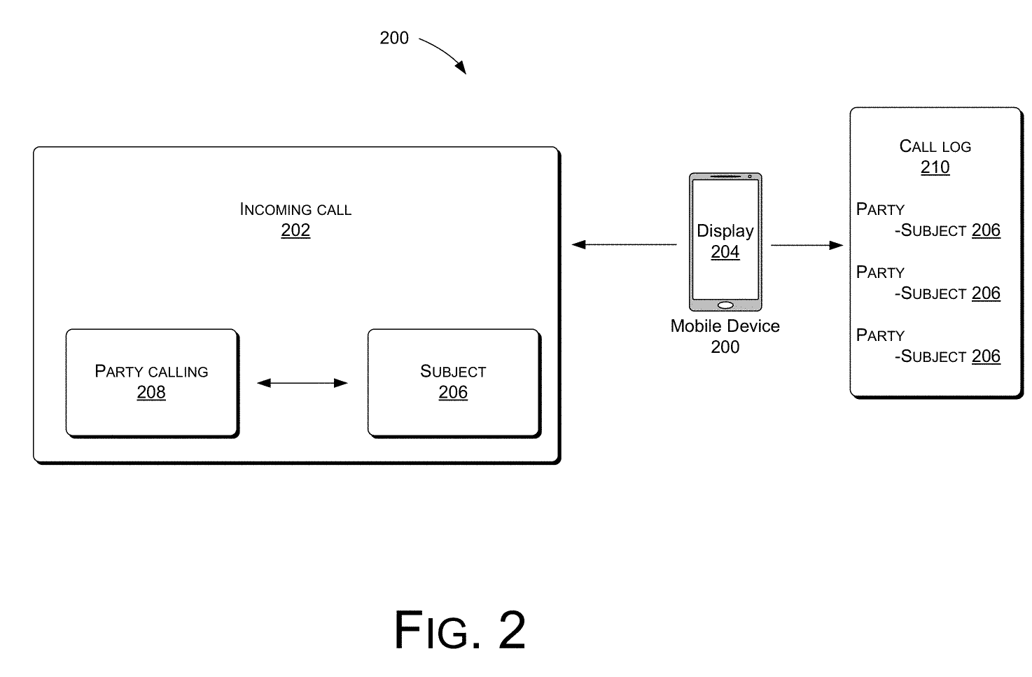

FIG. 2 schematically illustrates a mobile device 200 for use within a wireless communication network, such as, for example, wireless communication network 100. The mobile device 200 may correspond to a UE 104 of FIG. 1.

In accordance with various embodiments, an incoming call 202 (or video call) may be received by the mobile device 200. Information relating to the incoming call 202 may be displayed on a display 204 of the mobile device 200 or may be audibly provided by the mobile device 200. The information may include a subject 206 related to the incoming call 202. Additionally, the information may include an identification 208 of the party making the incoming call 202 to the mobile device 200. In embodiments, the information relating to the incoming call 202 may be provided audibly by the mobile device 200.

As is known, a call log 210 is generally maintained by mobile devices 200. Such call logs 210 allow for a user of the mobile device 200 to see a history or log of incoming and/or outgoing calls for the mobile device 200. Generally, the call log 210 includes the identification 208 of the party that made the incoming call 202 (or the party to whom an outgoing call was made). In embodiments, the subject 206 of the incoming call 202 is also stored and included within the call log 210 with information identifying the party making the incoming call. In embodiments, a subject 206 of an outgoing call is also stored and included within the call log 210 with information identifying the party to whom the outgoing call is made. The party making the incoming call 202 (or to whom an outgoing call is made) may be identified by a name, including a business or entity name, and/or a phone number. The call log 210 may also include further information as to the date and time the incoming call was received, whether the call was missed and/or refused, accepted, etc.

In embodiments, the subject 206 is included with incoming calls 202 within wireless communication networks, such as, wireless communication network 100. Thus, calls including information relating to the subject 206 of the call can be made using various wireless communication protocols or standards as described with respect to wireless communication network 100, including, but not limited to, Long-Term Evolution (LTE), Advanced LTE, Voice over Internet Protocol (VoIP), Voice over Long-Term Evolution (VoLTE), etc. Generally, in order to include the information relating to the subject 206 with the incoming call 202, one or more specifications or protocols may be utilized. For example, a session initiation protocol (SIP) may be utilized. An example of one such session protocol includes Request for Comments (RFC) 3261. Another example protocol includes a session description protocol (SDP) and more particularly, RFC 4317. Other SDPs include RFC 4566 and RFC 3264.

In order to include the subject 206 with the incoming call 202, when a party initiates a call making process, i.e. begins to place a call to another party, the party is prompted for information regarding the subject of the call being made. Once the information has been provided by the party, the party can then make the call, i.e. the call is transmitted. The information regarding the subject 206 can be provided audibly, e.g., by speaking the information, or manually, e.g., by typing the information. Additionally, a preprogrammed list of subjects can also be provided to the party and the party can make a selection from the list. The list can include various subjects such as, but not limited to, urgent, emergency, call back, please do not ignore, social, business, personal, catch-up, confirming plans, returning your call, etc.

In accordance with various embodiments, a subject 206 for a call may be an emergency. In such embodiments, the subject 206 can include the location of the party making the call. The location can be entered by the party making the call or can be automatically provided by the device being used to make the call, either by the device itself or by the wireless communication network, in response to emergency or urgent (or a similar term) being included in the subject. Additionally, the subject 206 may also, or instead, include the type of emergency so that the recipient of the call can know what services need to be provided to the party making the call in response to the emergency. In embodiments, if urgent or emergency (or a similar term) is entered or selected from a preprogrammed list of subjects, a visual and/or audible notification may be provided by the receiving mobile device 200, e.g., a flashing display, a different and/or louder ringtone or announcement, etc.

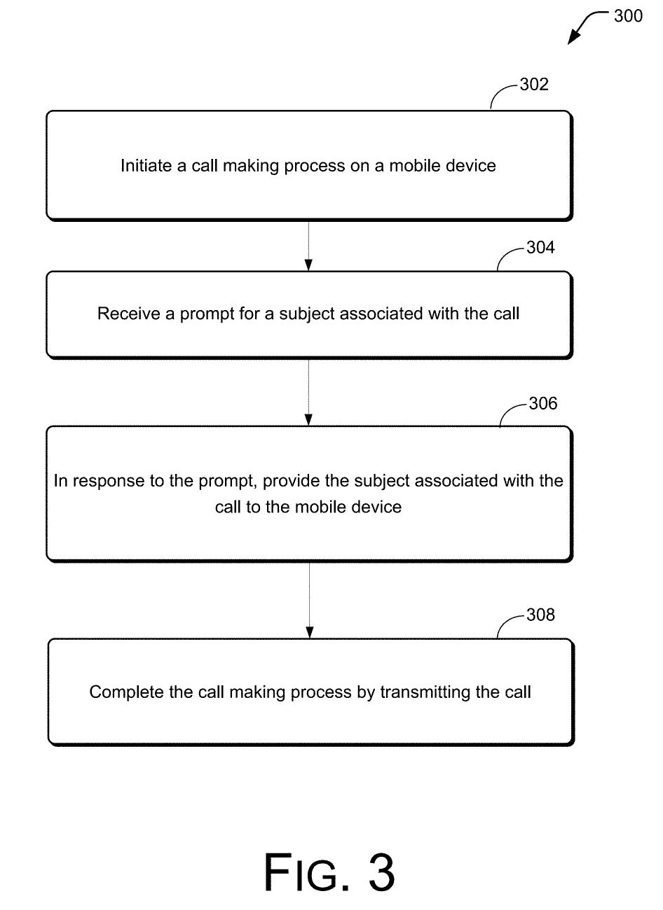

FIG. 3 is a flowchart illustrating a method 300 of making a call within a wireless communication network, e.g., wireless communication network 100 of FIG. 1, where the call includes a subject associated with the call. As illustrated, at block 302, a call making process is initiated on a mobile device. At block 304, a prompt is received for a subject associated with the call. At block 306, in response to the prompt, the subject associated with the call is provided to the mobile device. At block 308, the call making process is completed by transmitting the call.

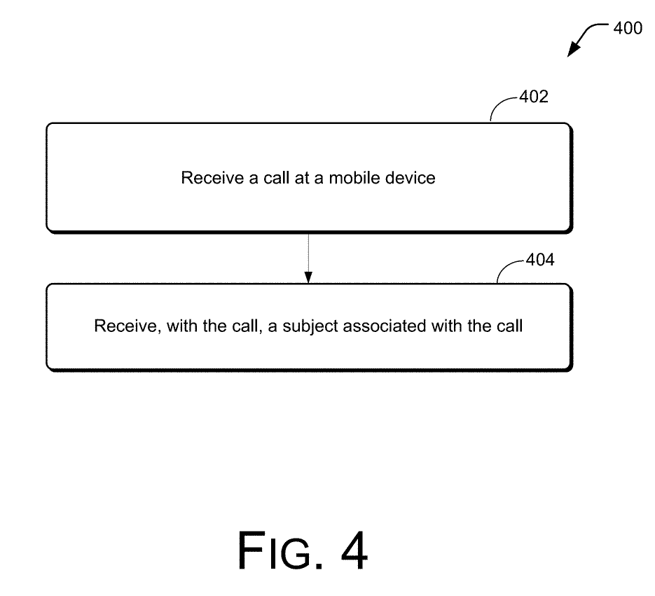

FIG. 4 is a flowchart illustrating a method 400 of receiving a call within a wireless communication network, e.g., wireless communication network 100 of FIG. 1, where the call includes a subject associated with the call. As illustrated, at block 402, a call is received at a mobile device. At block 404, a subject associated with the call is received with the call.

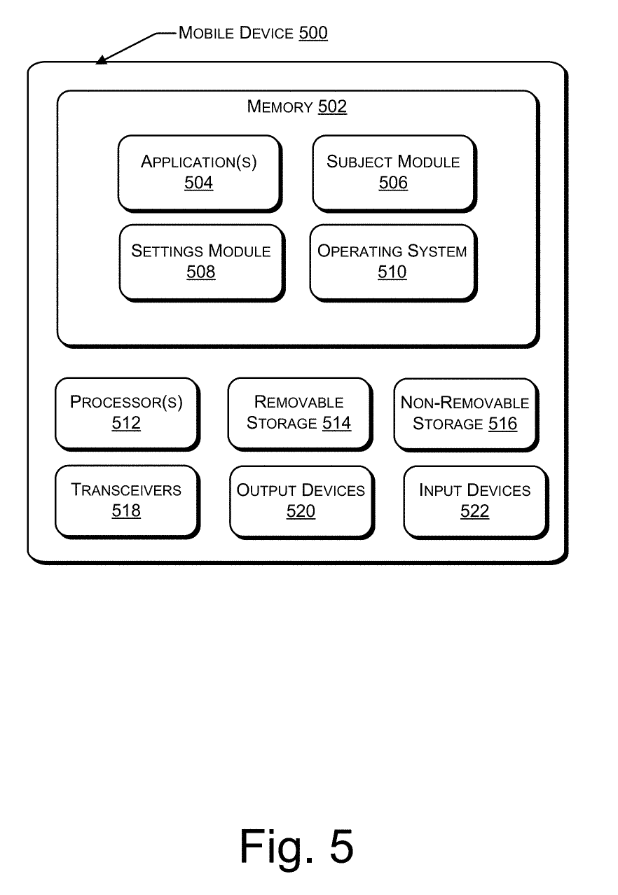

FIG. 5 illustrates a component level view of a mobile device 500, such as UE 104, configured to function within wireless communication network 100. As illustrated, the mobile device 500 comprises a system memory 502 storing application(s) 504, a subject module 506, a settings module 508, and an operating system 510. Also, the mobile device 500 includes processor(s) 512, a removable storage 514, a non-removable storage 516, transceivers 518, output device(s) 520, and input device(s) 522. In various implementations, system memory 502 is volatile (such as RANI), non-volatile (such as ROM, flash memory, etc.) or some combination of the two. In some implementations, the processor(s) 512 is a central processing unit (CPU), a graphics processing unit (GPU), or both CPU and GPU, or any other sort of processing unit. The subject module 506 is configured to allow a user of the mobile device 500 to include a subject, such as subject 206, with outgoing calls, as described herein. The subject module 506 is also configured to display a subject, such as subject 206, on a display of the mobile device 500 with incoming calls.

The mobile device 500 may also include additional data storage devices (removable and/or non-removable) such as, for example, magnetic disks, optical disks, or tape. Such additional data storage may include removable storage 514 and non-removable storage 516.

Non-transitory computer-readable media may include volatile and nonvolatile, removable and non-removable tangible, physical media implemented in technology for storage of information, such as computer readable instructions, data structures, program modules, or other data. System memory 502, removable storage 514 and non-removable storage 516 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the user device 500. Any such non-transitory computer-readable media may be part of the user device 500.

In some implementations, the transceivers 518 include any sort of transceivers known in the art. For example, the transceivers 518 may include a radio transceiver that performs the function of transmitting and receiving radio frequency communications via an antenna. Also or instead, the transceivers 518 may include wireless modem(s) to may facilitate wireless connectivity with other computing devices. Further, the transceivers 518 may include wired communication components, such as an Ethernet port, for communicating with other networked devices.

In some implementations, the output devices 520 include any sort of output devices known in the art, such as a display (e.g., a liquid crystal display), speakers, a vibrating mechanism, or a tactile feedback mechanism. Output devices 520 also include ports for one or more peripheral devices, such as headphones, peripheral speakers, or a peripheral display.

In various implementations, input devices 522 include any sort of input devices known in the art. For example, input devices 522 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

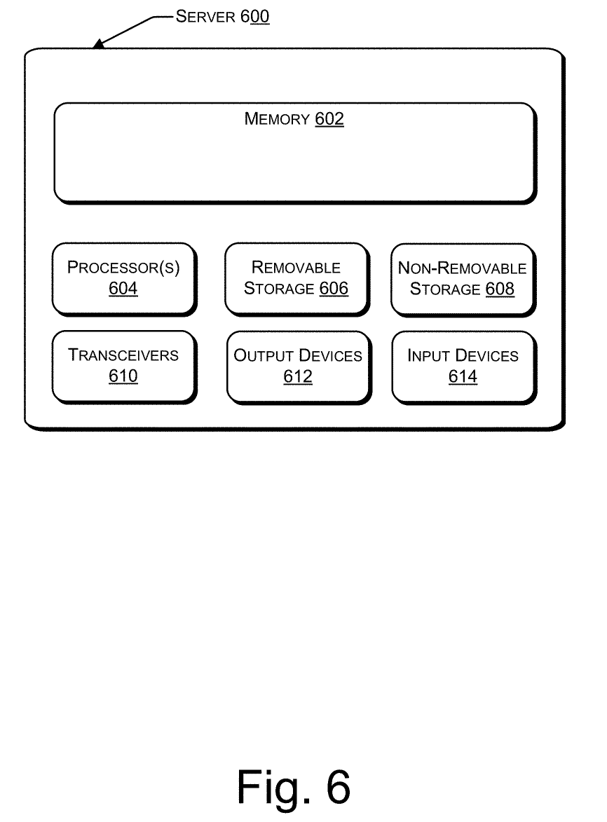

FIG. 6 illustrates a component level view of a server configured for use within a wireless communication network, e.g., wireless communication network 100 in order to provide various services within the wireless communication network, according to the techniques described herein. The server 600 may be located in the RNC or gateway 110. Additionally, the server 600 may be a separate entity located separately from the RNC 110. As illustrated, the server 600 comprises a system memory 602. Also, the server 600 includes processor(s) 604, a removable storage 606, a non-removable storage 608, transceivers 610, output device(s) 612, and input device(s) 614.

In various implementations, system memory 602 is volatile (such as RAM), non-volatile (such as ROM, flash memory, etc.) or some combination of the two. In some implementations, the processor(s) 604 is a central processing unit (CPU), a graphics processing unit (GPU), or both CPU and GPU, or any other sort of processing unit.

The server 600 may also include additional data storage devices (removable and/or non-removable) such as, for example, magnetic disks, optical disks, or tape. Such additional storage is illustrated in FIG. 6 by removable storage 606 and non-removable storage 608.

Non-transitory computer-readable media may include volatile and nonvolatile, removable and non-removable tangible, physical media implemented in technology for storage of information, such as computer readable instructions, data structures, program modules, or other data. System memory 602, removable storage 606 and non-removable storage 608 are all examples of non-transitory computer-readable media. Non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the server 600. Any such non-transitory computer-readable media may be part of the server 600.

In some implementations, the transceivers 610 include any sort of transceivers known in the art. For example, the transceivers 610 may include wired communication components, such as an Ethernet port, for communicating with other networked devices. Also or instead, the transceivers 610 may include wireless modem(s) to may facilitate wireless connectivity with other computing devices. Further, the transceivers 610 may include a radio transceiver that performs the function of transmitting and receiving radio frequency communications via an antenna.

In some implementations, the output devices 612 include any sort of output devices known in the art, such as a display (e.g., a liquid crystal display), speakers, a vibrating mechanism, or a tactile feedback mechanism. Output devices 612 also include ports for one or more peripheral devices, such as headphones, peripheral speakers, or a peripheral display.

In various implementations, input devices 614 include any sort of input devices known in the art. For example, input devices 614 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

1. A method of placing a call within a wireless communication network, the method comprising:
initiating, with a mobile device, a call making process;
presenting, with the mobile device, a prompt for a subject associated with a call;
receiving, at the mobile device in response to the prompt, subject information indicating that the subject is an emergency;
obtaining, with the mobile device, location information associated with the emergency upon receipt of the subject information indicating that the subject is an emergency;
adding the location information to the subject information; and
transmitting the call and the subject information from the mobile device to a recipient device over a wireless communication network.

2. A method of placing a call within a wireless communication network, the method comprising:
initiating, with a mobile device, a call making process;
presenting, with the mobile device, a prompt for a subject associated with a call, wherein the prompt for the subject associated with the call comprises a preprogrammed list of subjects including an emergency subject;
receiving, at the mobile device in response to the prompt, a selection of the emergency subject from the preprogrammed list;
obtaining, with the mobile device, location information associated with the emergency subject upon receipt of the selection of the emergency subject from the preprogrammed list; and
transmitting the call, the emergency subject, and the location information from the mobile device to a recipient device over a wireless communication network.

3.-6. (canceled)

7. The method of claim 2, wherein the call is a voice call.

8. The method of claim 2, wherein the call is a video call.

9. (canceled)

10. (canceled)

11. The method of claim 2, further comprising storing the subject information and/or the location information associated with the call in a call log of the mobile device.

12.-20. (canceled)

21. The method of claim 2, further comprising:
obtaining, with the mobile device, a type of emergency associated with the emergency subject following selection of the emergency subject from the preprogrammed list; and
transmitting the type of emergency from the mobile device to the recipient device along with the call, the emergency subject, and the location information.

22. The method of claim 2, wherein obtaining the location information comprises automatically determining the mobile device's current location.

23. The method of claim 2, wherein obtaining the location information comprises receiving location input from a user of the mobile device.

24. The method of claim 2, further comprising:
obtaining, with the mobile device, an identifier of a party placing the call; and
transmitting the identifier of the party from the mobile device to the recipient device along with the call, the emergency subject, and the location information.

25. The method of claim 1, further comprising:
obtaining, with the mobile device, a type of emergency associated with the emergency; and
adding the type of emergency to the subject information prior to transmitting the call and the subject information.

26. The method of claim 1, wherein the prompt is a preprogrammed list of subjects including an emergency subject, and wherein receiving the subject information comprises receiving a selection of the emergency subject from the preprogrammed list of subjects.

27. The method of claim 1, wherein the prompt is a manual entry prompt, and wherein receiving the subject information comprises receiving a manual entry of the subject information indicating that the subject is an emergency.

28. The method of claim 1, wherein the prompt is an audible entry prompt, and wherein receiving the subject information comprises receiving an audible entry of the subject information indicating that the subject is an emergency.

29. The method of claim 1, wherein obtaining the location information comprises automatically determining the mobile device's current location.

30. The method of claim 1, wherein obtaining the location information comprises receiving location input from a user of the mobile device.

31. The method of claim 1, wherein the call is a voice call.

32. The method of claim 1, wherein the call is a video call.

33. The method of claim 1, further comprising storing the subject information and/or the location information associated with the call in a call log of the mobile device.

34. The method of claim 1, further comprising:
obtaining, with the mobile device, an identifier of a party placing the call; and
transmitting the identifier of the party from the mobile device to the recipient device along with the call and the subject information.
